(19) United States
(12) Patent Application Publication
(10) Pub. No.: US 2024/0045512 A1
(43) Pub. Date: Feb. 8, 2024

(54) COMPUTER MOUSE MODULE WITH AN ANGLED AND/OR SLOPED FRONT

(71) Applicant: Microsoft Technology Licensing, LLC, Redmond, WA (US)

(72) Inventors: Paul Christopher KOS, Shenzhen (CN); John Franciscus Marie HELMES, Steijl (NL); Gabrielle DeAnne MICHEL, Snohomish, WA (US); Robert Bryce JOHNSON, Sammamish, WA (US); Solomon Stone ROMNEY, Bothell, WA (US); Wen Zhao ZHANG, Shenzhen (CN); Guangwen ZHOU, Shenzhen (CN); Yi Wei ZHANG, Shenzhen (CN)

(21) Appl. No.: 17/933,039

(22) Filed: Sep. 16, 2022

Related U.S. Application Data
(60) Provisional application No. 63/370,492, filed on Aug. 4, 2022.

(51) Int. Cl. G06F 3/0338; G06F 3/0354

(52) U.S. Cl. CPC G06F 3/0338; G06F 3/03543

(57) ABSTRACT

A computer mouse module includes a body having a front face, a lower side, and a lower front edge portion that extends between the lower side and the front face. The lower front edge portion includes a slope between the front face and the lower side. The computer mouse module includes a movement sensor held along the slope of the lower front edge portion of the body. The movement sensor is configured to detect movement of the computer mouse module along a tracking surface at at least two angular positions of a longitudinal axis of the body relative to the tracking surface.

### CROSS-REFERENCE TO RELATED APPLICATION

This application claims priority to U.S. Provisional Patent Application No. 63/370,492, entitled “COMPUTER MOUSE MODULE,” filed on Aug. 4, 2022, the disclosure of which is incorporated herein by reference in its entirety.

### BACKGROUND

A computer mouse is generally a hand-held device that detects two-dimensional (2D) motion relative to a surface. A computer mouse is an input device for a computer and the 2D motion detected by the mouse is input into the computer and used to control a pointer of a graphical user interface associated with the computer. There have been variations upon the original wired computer mouse including: wireless computer mice that transmit data to a computer via infrared radiation or radio; foldable computer mice; and ergonomic computer mice that are designed to increase comfort and avoid injuries such as carpal tunnel syndrome or other repetitive strain injuries.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

According to a first aspect there is a computer mouse module that includes a body having a front face, a lower side, and a lower front edge portion that extends between the lower side and the front face. The lower front edge portion includes a slope between the front face and the lower side. The computer mouse module includes a movement sensor held along the slope of the lower front edge portion of the body. The movement sensor is configured to detect movement of the computer mouse module along a tracking surface at at least two angular positions of a longitudinal axis of the body relative to the tracking surface.

The slope of the lower front edge portion may include a curvature.

The slope of the lower front edge portion may include a convexly curved path between the front face and the lower side of the body.

The movement sensor may be configured to detect movement of the computer mouse module along the tracking surface: at a first angular position of the body relative to the tracking surface wherein the longitudinal axis of the body extends approximately parallel to the tracking surface; and at a second angular position of the body relative to the tracking surface wherein the longitudinal axis of the body extends at an approximate oblique angle relative to the tracking surface.

The movement sensor may be configured to detect movement of the computer mouse module along the tracking surface over a range of approximately oblique angles of the longitudinal axis of the body relative to the tracking surface.

The body may include a foot extending along the slope of the lower front edge portion of the body.

The body may include a foot extending along a convexly curved path along the slope of the lower front edge portion of the body.

The body may include a physical connector for detachably attaching a handle portion to the body of the computer mouse module.

According to a second aspect there is a computer mouse module that includes a body extending a length from a rear to a front. The front of the body includes a front face. The front face is angled backwardly toward the rear of the body. The computer mouse module also includes at least one of a cable or a cable connector extending at the front face of the body.

The body may extend a height along a central height axis from a lower side of the body to an upper side of the body. The front face may extend from a lower edge of the front face toward an upper edge of the front face in a direction generally toward the central height axis of the body.

The body may extend a height along a central height axis from a lower side of the body to an upper side of the body. The front face may be angled between approximately 5° and approximately 20° relative to the central height axis.

The at least one of a cable or a cable connector may include a universal serial bus (USB) receptacle connector.

According to a third aspect there is a computer mouse module that includes a body extending a length from a rear to a front. The body includes a front face, a lower side, and a lower front edge portion that extends between the lower side and the front face. The lower front edge portion includes a slope between the front face and the lower side. The front face is angled backwardly toward the rear of the body. The computer mouse module includes a movement sensor held along the slope of the lower front edge portion of the body. The movement sensor is configured to detect movement of the computer mouse module along a tracking surface at at least two angular positions of a longitudinal axis of the body relative to the tracking surface. The computer mouse module includes at least one of a cable or a cable connector extending at the front face of the body.

The slope of the lower front edge portion may include a convexly curved path between the front face and the lower side of the body.

The movement sensor may be configured to detect movement of the computer mouse module along the tracking surface: at a first angular position of the body relative to the tracking surface wherein the longitudinal axis of the body extends approximately parallel to the tracking surface; and at a second angular position of the body relative to the tracking surface wherein the longitudinal axis of the body extends at an approximate oblique angle relative to the tracking surface.

The movement sensor may be configured to detect movement of the computer mouse module along the tracking surface over a range of approximately oblique angles of the longitudinal axis of the body relative to the tracking surface.

The body may include a foot extending along a convexly curved path along the slope of the lower front edge portion of the body.

The body may extend a height along a central height axis from the lower side of the body to an upper side of the body. The front face may be angled between approximately 5° and approximately 20° relative to the central height axis.

The at least one of a cable or a cable connector may include a universal serial bus (USB) receptacle connector.

The body may include a physical connector for detachably attaching a handle portion to the body of the computer mouse module.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an elevational view of a computer mouse module according to an implementation;

FIGS. 1A-1D are isometric views of computer mouse modules according to various implementations.

FIG. 2 is an elevational view of a computer mouse module according to an implementation;

FIG. 3 is an elevational view of a computer mouse module according to an implementation;

FIG. 4 illustrates different longitudinal angular positions of the computer mouse module shown in FIG. 1 according to an implementation;

FIG. 5 is an elevational view of a computer mouse module having a handle portion attached thereto according to an implementation;

FIG. 6 is an elevational view of a computer mouse module having a handle portion attached thereto according to an implementation;

FIG. 7 is another elevational view of the computer mouse module shown in FIG. 1 according to an implementation;

FIG. 8 is an elevational view of a computer mouse module according to an implementation;

FIG. 9 is a plan view of an input device according to an implementation;

FIG. 10 is an elevational view of the input device shown in FIG. 10 according to an implementation;

FIG. 11 illustrates an input device assembly according to an implementation;

FIG. 12 illustrates an input device assembly according to an implementation;

FIG. 13 illustrates an input device assembly according to an implementation;

FIG. 14 illustrates an input device assembly according to an implementation;

FIG. 15 illustrates an input device assembly according to an implementation;

FIG. 16 illustrates an input device assembly according to an implementation;

FIG. 17 illustrates an input device assembly according to an implementation; and

FIG. 18 illustrates an input device assembly according to an implementation.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

While various spatial and directional terms, such as “upper,” “lower,” “vertical,” “horizontal,” and/or the like are used to describe implementations of the present application, it is understood that such terms are merely used with respect to the orientations shown in the drawings. The orientations can be inverted, rotated, or otherwise changed, such that an upper side becomes a lower side if the structure is flipped 180°, becomes a left side or a right side if the structure is pivoted 90°, etc.

Ergonomic mice are designed to avoid injuries but may not provide an accessible design suitable for use by someone who has a limitation in their motor skills which may occur for a wide variety of reasons, such as neurological disorders like Cerebral Palsy and Parkinson's disease. The examples described below are not limited to implementations which solve any or all of the disadvantages of known mice.

Certain implementations provide a computer mouse module that includes a body having a front face, a lower side, and a lower front edge portion that extends between the lower side and the front face. The lower front edge portion includes a slope between the front face and the lower side. The computer mouse module includes a movement sensor held along the slope of the lower front edge portion of the body. The movement sensor is configured to detect movement of the computer mouse module along a tracking surface at at least two angular positions of a longitudinal axis of the body relative to the tracking surface.

Certain implementations provide a mouse module that is adaptable to a user's particular needs. For example, by providing a mouse module that is functional to detect movement along a tracking surface at at least two longitudinal angular positions of a body of the mouse module relative to the tracking surface, the user can select an angular position that suits the user from among different functional angular positions provided by the mouse module. For example, a user may select an angular position of the mouse module that is adapted for the user's needs, hand-size, hand strength, hand shape, finger strength, finger shape, and/or the like. Moreover, and for example, a user may select an angular position of the mouse module that provides an ergonomic benefit to the user, increases the user's comfort while using the mouse module, and/or decreases the likelihood of injury (e.g., carpal tunnel syndrome, other repetitive strain injuries, etc.) resulting from use of the mouse module. In another example, an angular position of the mouse module may be selected to increase accessibility, for example: to accommodate a particular (e.g., custom, bespoke, specialized, etc.) handle portion; for a user who has a motor skill limitation (e.g., neurological disorders, Cerebral Palsy, Parkinson's disease, etc.); to enable the mouse module to be controlled with a foot, elbow, head, chin, residual limb, and/or the like; to accommodate user's having relatively less strength, movement, and/or dexterity in their arms, hands, fingers, and/or the like; etc.

Certain implementations provide a computer mouse module that includes a body extending a length from a rear to a front. The front of the body includes a front face. The front face is angled backwardly toward the rear of the body. The computer mouse module also includes at least one of a cable or a cable connector extending at the front face of the body.

Certain implementations increase the flexibility of a mouse module. For example, the backward angle of the front face toward the rear of the body of the mouse module enables the mouse module to be used at oblique longitudinal angular positions while a cable extends from the front face of the mouse module. At least some known mice are not functional at longitudinal angles that are non-parallel to the tracking surface when a cable is connected or hardwired to the mouse. For example, the end of the cable that is connected or hardwired to at least some known mice will engage in physical contact with (e.g., abut, bump, push, contact, etc.) the tracking surface, and thereby inhibit movement and/or function of the mouse, when the mouse is tilted forward into an oblique longitudinal angular position relative to the tracking surface. However, the backward angle of the front face disclosed herein enables a mouse module to function with a cable extending from the front face even when a longitudinal axis of the mouse module is angled approximately obliquely relative to the tracking surface. For example, the backward angle of the front face prevents the cable from engaging in physical contact with the tracking surface when the body of the mouse module is tilted forward into an oblique longitudinal angular position.

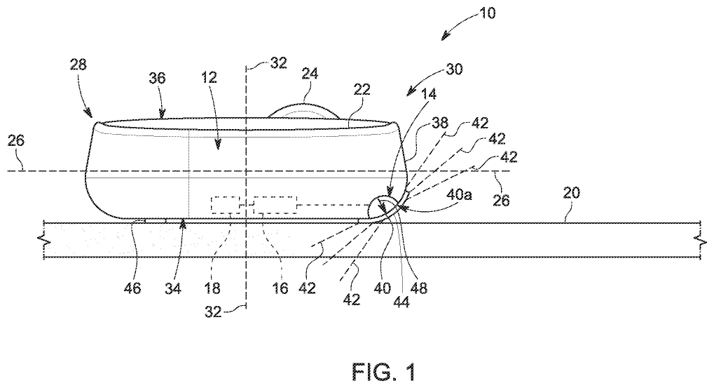

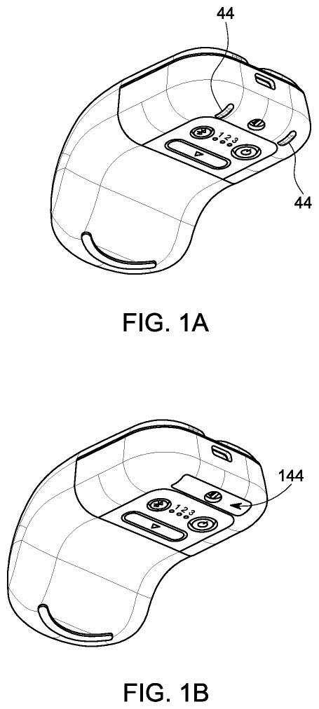

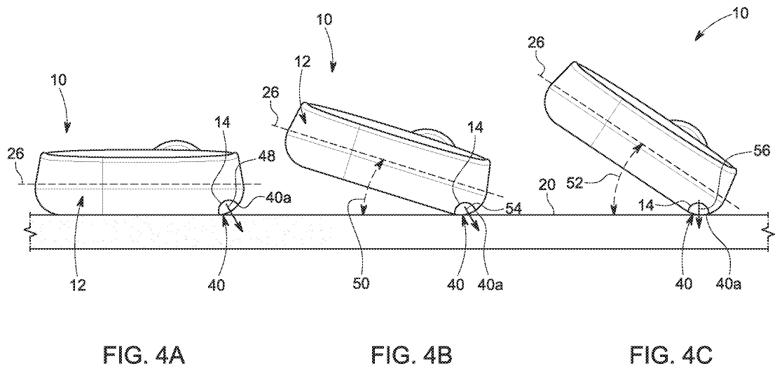

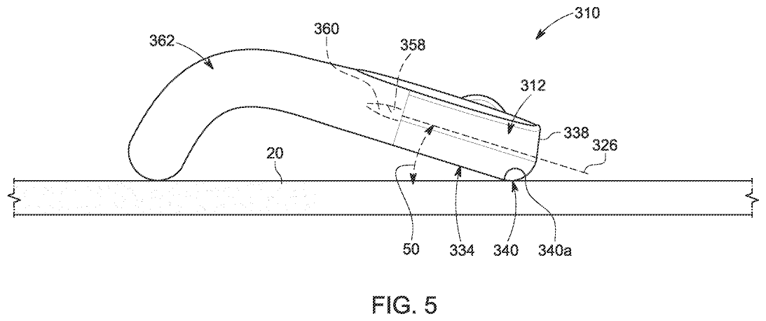

FIG. 1 is an elevational view of a computer mouse module 10 according to an implementation. The mouse module 10 includes a body 12, one or more movement sensors 14 held by the body 12, one or more encoders 16 operatively connected to the movement sensor 14, and one or more transmitters 18 operatively connected to the encoder 16. In operation, movement of the body 12 of the mouse module 10 along a tracking surface 20 is detected by the movement sensor 14 and encoded by the encoder 16 for transmission to a connected device (not shown; e.g., a computer, a tablet, a phone, a portable electronic device, etc.). In some implementations, the mouse module 10 is removably attachable (e.g., detachable from and re-attachable to, etc.) a handle portion (not shown in FIG. 1) that facilitates a user holding, grasping, manipulating, and/or the like the mouse module 10, for example the handle portions 362 and 462 described below with respect to FIGS. 5 and 6, etc.).

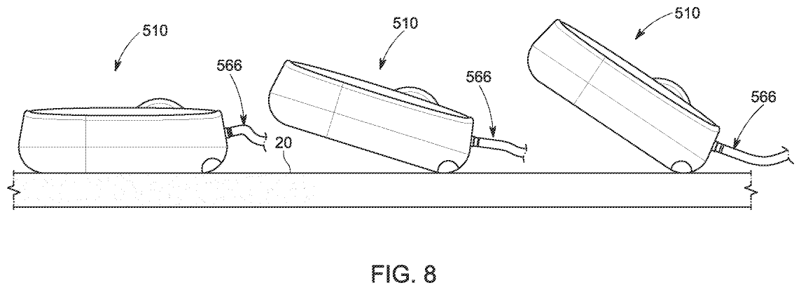

In the exemplary implementation shown in FIG. 1, the mouse module 10 includes a pair of input buttons 22 (only one is visible in FIG. 1) and a scroll wheel 24 arranged between the input buttons 22. However, the mouse module 10 may additionally or alternatively include any other number, arrangement, configuration, type, and/or the like of input(s), such as, but not limited to, touch sensitive surfaces, rocker switches, joysticks, direction pads (d-pads), haptic modules, and/or the like. For example, in some implementations button and/or scroll functionality is provided by one or more touch sensitive surfaces and, optionally, haptic feedback is provided for a button click and/or a mouse scroll vibration via a haptic module. In some implementations, the mouse module 10 is modular such that different inputs can be selectively interchanged to selectively provide the mouse module 10 with different input functionality (e.g., the tactile switches 678 and input elements 680 described below with respect to FIGS. 9-18, etc.).

The mouse module 10 may be powered by any suitable power source(s) that enables the mouse module 10 to function as described and/or illustrated herein, such as, but not limited to, one or more batteries (e.g., rechargeable batteries, disposable batteries, permanent batteries, removable batteries, etc.), a wired connection (e.g., a universal serial bus (USB) connection, a cable that is hard-wired to the mouse module 10, an electrical connector for removable connection to a cable, etc.) for receiving power from a power supply (e.g., a computer, a tablet, a phone, a portable electronic device, a wall outlet, etc.), one or more capacitors and/or one or more super capacitors that use motion of the mouse module 10 to generate a charge that is stored in the capacitor(s) and/or super capacitor(s) to power the mouse module 10. In some implementations, in addition or alternatively to a wired connection that provides power to the mouse module 10, the mouse module 10 includes a wired connection (e.g., a USB connection, a cable that is hard-wired to the mouse module 10, an electrical and/or optical connector for removable connection to a cable, etc.) for transmitting data between the mouse module 10 and the connected device. In one example, the wired connection is a USB connection and the mouse module 10 includes a USB transceiver and/or the like. In addition or alternatively to a wired connection, the mouse module 10 may wirelessly communicate data with the connected device, such as, but not limited to, using Bluetooth®, WiFi®, a cellular network, infrared radiation, radio signals, and/or the like.

As will be described below, the body 12 and the movement sensor 14 of the mouse module 10 are configured such that the mouse module 10 is functional to detect movement along the tracking surface 20 at at least two longitudinal angular positions of the body 12 relative to the tracking surface 20. The body 12 extends a length along a longitudinal axis 26 from a rear 28 of the body 12 to a front 30 of the body 12. The body 12 extends a height along a central height axis 32 from a lower side 34 of the body 12 to an upper side 36 of the body 12. The front 30 of the body 12 includes a front face 38 of the body 12. The front of the body 12 also includes a lower front edge portion 40 that extends between the lower side 34 and the front face 38 of the body 12. For example, as shown in FIG. 1, the exemplary implementation of the lower front edge portion 40 extends from the lower side 34 to the front face 38, and vice versa.

As shown in FIG. 1, the lower front edge portion 40 includes a slope 40a between the front face 38 and the lower side 34. For example, at least one segment of the path of the lower front edge portion 40 between the front face 38 and the lower side 34 is angled obliquely relative to each of the front face 38 and the lower side 34 (e.g., as indicated by the exemplary tangent indicator lines 42 shown in FIG. 1, etc.). In some implementations, the slope 40a of the lower front edge portion 40 includes a curvature. For example, in the exemplary implementation of FIG. 1, the slope 40a of the lower front edge portion 40 includes a convexly curved path between the front face 38 and the lower side 34 of the body 12, as can be seen in FIG. 1. The radius of the curvature of the slope 40a of the lower front edge portion may have any dimension that enables the mouse module 10 to function as described and/or illustrated herein, such as, but not limited to, between approximately 8 millimeters (mm) and approximately 18 mm, between approximately 10 mm and approximately 16 mm, approximately 13 millimeters, and/or the like.

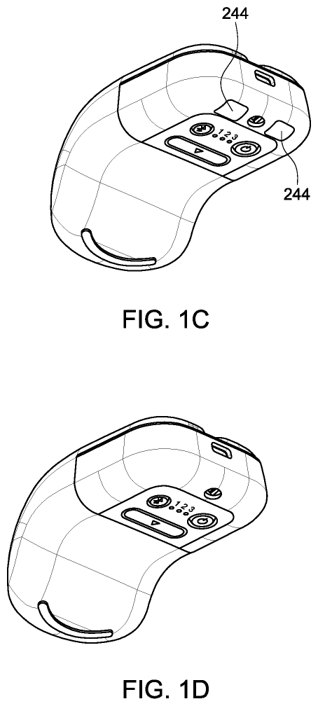

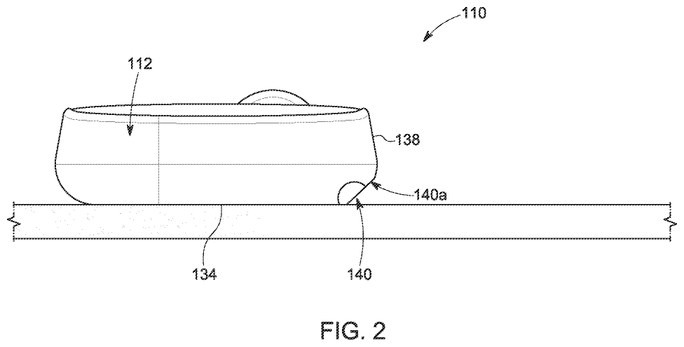

Although the exemplary implementation shown in FIG. 1 illustrates the slope as including the curved path between the front face 38 and the lower side 34, the slope 40a may include one or more segments that extend along an approximately straight (e.g., linear, etc.) path between the front face 38 and the lower side 34 that is angled obliquely relative to each of the front face 38 and the lower side 34. For example, FIG. 2 illustrates a mouse module 110 having a body 112 that includes a lower front edge portion 140 having a slope 140a between a front face 138 and a lower side 134 of the body 112. The slope 140a includes a single segment that extends along an approximately straight (e.g., linear, etc.) path between the front face 138 and the lower side 134 that is angled obliquely relative to each of the front face 138 and the lower side 134. Moreover, and for example, FIG. 3 illustrates a mouse module 210 having a body 212 that includes a lower front edge portion 240 having a slope 240a between a front face 238 and a lower side 234 of the body 212. The slope 240a includes a plurality of segments 240aa that extend along approximately straight (e.g., linear, etc.) paths between the front face 238 and the lower side 234 that are each angled obliquely relative to each of the front face 238 and the lower side 234. Referring again to FIG. 1, in some implementations the slope 40a of the lower front edge portion 40 includes a combination of at least one straight segment and at least one curved segment.

Optionally, the body 12 of the mouse module 10 includes one or more feet 44 that extend along the slope 40a of the lower front edge portion 40. Each foot 44 provides a contact point at which the body 12 of the mouse module 10 engages in physical contact with (e.g., rests on, pressed against, held over, held on, etc.) the tracking surface 20. In addition to extending along the slope 40a as described above, one or more of the feet 44 optionally extend along a portion of the lower side 34. The body 12 optionally includes one or more feet 46 that extend more rearward along the body 12 as compared to the feet 44. In some implementations (e.g., implementations that do not include any feet 44, the implementations shown in FIGS. 2 and 3, etc.), the lower front edge portion 40 and/or the lower side 34 of the body 12 may engage in physical contact with the tracking surface 20 during operation of the mouse module 10.

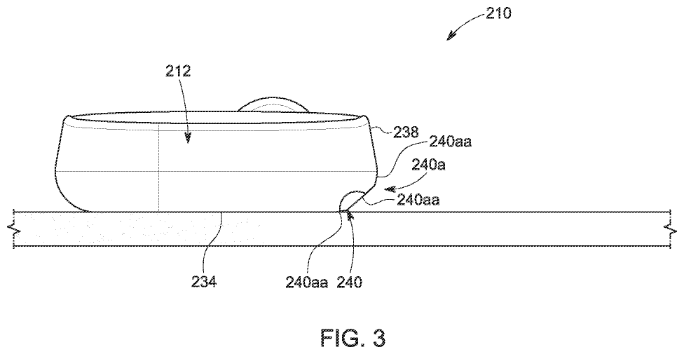

Each foot 44 extends along a complementary path with the segment of the slope along which the foot 44 extends. In other words, the path of each foot 44 follows the profile of the path of the corresponding segment of the slope 40a. In the exemplary implementation shown in FIG. 1, the feet 44 extend along convexly curved paths along the slope 40a of the lower front edge portion 40 of the body 12. As described below with respect to the slope 40a, by following the profile of the path of the corresponding segment of the slope each foot 44 facilitates enabling the mouse module 10 as functional to detect movement along the tracking surface 20 at at least two longitudinal angular positions of the body 12 relative to the tracking surface 20 (e.g., the longitudinal angular positions shown in FIGS. 4A, 4B, and 4C, other longitudinal angular positions now shown herein, etc.). The exemplary implementation of the body 12 includes two feet 44 (only one is visible in FIG. 1), but the body 12 may include any number of the feet 44. Each foot 44 may be fabricated from and/or include any material(s), such as, but not limited to, rubber, a polymer, plastic, a thermoplastic, polyoxymethylene (POM), polytetrafluoroethylene (PTFE), an elastomeric material, and/or the like. Each foot 44 may include any size, shape, geometry, and/or the like. For example, FIG. 1A illustrates the feet 44 from another angle; FIGS. 1B and 1C illustrate a foot 144 and feet 244, respectively, according to other implementations; and FIG. 1D illustrates an implementation that does not include any feet.

As can be seen in FIG. 1, the movement sensor 14 (e.g., an optical sensor, a roller ball, etc.) is held by the body 12 along the slope 40a of the lower front edge portion 40. The movement sensor 14 is configured to detect movement of the mouse module 10 along the tracking surface 20. For example, the movement sensor 14 extends at a position along the slope 40a such that the movement sensor 14 is directed towards the tracking surface 20 (e.g., faces in a direction that intersects the tracking surface, is positioned to roll along the tracking surface, etc.). As shown in FIG. 1, when the body 12 of the mouse module 10 is at an angular position wherein the longitudinal axis 26 of the body 12 extends approximately parallel to the tracking surface 20, the movement sensor 14 faces in a direction 48 towards the tracking surface 20 such that the movement sensor 14 is configured to detect movement of the mouse module 10 along the tracking surface 20. For example, the movement sensor 14 is positioned along the slope 40a such that light emitted by an optical sensor (not shown) of the movement sensor 14 intersects the tracking surface 20 when the body 12 is in the angular position shown in FIG. 1. Moreover, and for example, the movement sensor 14 is positioned along the slope 40a such that a roller ball (not shown) of the movement sensor 14 rolls along the tracking surface 20 when the body 12 is in the angular position shown in FIG. 1. The movement sensor 14 may include any other type of movement sensor 14 in addition or alternative to an optical sensor and/or a roller ball.

As described above, the mouse module 10 is functional to detect movement thereof along the tracking surface 20 in the approximately parallel angular position shown in FIGS. 1 and 4A (i.e., when the longitudinal axis 26 of the body 12 extends approximately parallel to the tracking surface 20). The slope 40a of the lower front edge portion 40 of the body 12 enables the mouse module 10 to be used in at least one other longitudinal angular position, for example at least one longitudinal angular position wherein the longitudinal axis 26 extends at an approximately oblique angle relative to the tracking surface 20. For example, the profile of the slope 40a enables the body 12 of the mouse module 10 to be tilted forward from the position shown in FIGS. 1 and 4A to the position shown in FIG. 4B, wherein the longitudinal axis 26 extends at an approximate oblique angle 50 relative to the tracking surface 20. In the exemplary implementation of the slope 40a, the profile of the slope 40a enables the body 12 to be tilted further forward to the position shown in FIG. 4C, wherein the longitudinal axis 26 extends at an approximate oblique angle 52 relative to the tracking surface 20. As shown in FIG. 4, the angle 52 is greater than the angle 50.

As shown in FIGS. 4B and 4C, the movement sensor 14 is positioned along the slope 40a of the lower front edge portion 40 of the body 12 such that the movement sensor 14 is configured to detect movement of the mouse module 10 along the tracking surface 20 at the longitudinal angular positions of the body 12 shown in FIGS. 4B and 4C (i.e., wherein the longitudinal axis 26 of the body 12 extends at the approximate oblique angles 50 and 52, respectively, relative to the tracking surface 20). For example, when the body 12 is at the angular position shown in FIG. 4B wherein the longitudinal axis 26 extends at the approximately oblique angle 50 relative to the tracking surface 20, the movement sensor 14 extends at a position along the slope 40a such that the movement sensor 14 faces in a direction 54 towards the tracking surface 20. The movement sensor 14 is thus configured to detect movement of the mouse module 10 along the tracking surface 20 in the longitudinal angular position of the mouse module 10 shown in FIG. 4B.

In the exemplary implementation of the mouse module 10, the movement sensor 14 is also configured to detect movement of the mouse module 10 along the tracking surface in the longitudinal angular position of the mouse module 10 shown in FIG. 4C. For example, when the body 12 is at the angular position shown in FIG. 4C wherein the longitudinal axis 26 extends at the approximately oblique angle 52 relative to the tracking surface 20, the movement sensor 14 extends at a position along the slope 40a such that the movement sensor 14 faces in a direction 56 towards the tracking surface 20.

The slope 40a of the lower front edge portion 40 and the position of the movement sensor 14 therealong thus enable the mouse module 10 as functional to detect movement along the tracking surface 20 at at least two longitudinal angular positions of the body 12 relative to the tracking surface 20 (e.g., the longitudinal angular positions shown in FIGS. 4A, 4B, and 4C, other longitudinal angular positions now shown herein, etc.). At least one of the longitudinal angular positions in which the mouse module 10 is functional to detect movement along the tracking surface 20 extends at an approximately oblique angle relative to the tracking surface 20 (e.g., the longitudinal angular position shown in FIG. 4B, the longitudinal angular position shown in FIG. 4C, etc.).

Although only two approximately obliquely angled positions are shown herein (i.e., the positions shown in FIGS. 4B and 4C), in the exemplary implementation, the curvature of the slope 40a of the lower front edge portion 40 enables the mouse module 10 as functional to detect movement along the tracking surface 20 over a continuous range of approximately oblique angles of the longitudinal axis 26 relative to the tracking surface 20. In some other implementations, the slope 40a of the lower front edge portion 40 includes any number of approximately straight (e.g., linear, etc.) segments to enable the mouse module 10 to be functional at any number of longitudinal angular positions of the body 12 (e.g., a stepped and/or multifaceted structure that enables functionality at a predetermined number of angular positions of the longitudinal axis 26 relative to the tracking surface 20, etc.). Each longitudinal angular position of the body 12 that is approximately obliquely angled relative to the tracking surface may have any oblique angle value relative to the tracking surface 20.

The mouse module 10 is adaptable to a user's particular needs. For example, because the mouse module 10 is functional to detect movement along the tracking surface 20 at at least two longitudinal angular positions of the body 12 relative to the tracking surface 20, the user can select an angular position that suits the user from among the different angular positions provided by the slope 40a. For example, a user may select an angular position of the mouse module 10 that is adapted for the user's needs, hand-size, hand strength, hand shape, finger strength, finger shape, and/or the like. Moreover, and for example, a user may select an angular position of the mouse module 10 that provides an ergonomic benefit to the user, increases the user's comfort while using the mouse module 10, and/or decreases the likelihood of injury (e.g., carpal tunnel syndrome, other repetitive strain injuries, etc.) resulting from use of the mouse module 10. In another example, an angular position of the mouse module 10 may be selected to increase accessibility, for example: to accommodate a particular (e.g., custom, bespoke, specialized, etc.) handle portion; for a user who has a motor skill limitation (e.g., neurological disorders, Cerebral Palsy, Parkinson's disease, etc.); to enable the mouse module to be controlled with a foot, elbow, head, chin, residual limb, and/or the like; to accommodate user's having relatively less strength, movement, and/or dexterity in their arms, hands, fingers, and/or the like; etc.

In some examples of the adaptability of the mouse module 10 to user needs, the slope 40a of the lower front edge portion 40 enables the attachment of a handle portion (not shown in FIG. 4) to the mouse module 10. For example, FIG. 5 illustrates a mouse module 310 that includes a body 312 having a lower front edge portion 340 that includes a slope 340a between a front face 338 and a lower side 334 of the body 312. The body 312 includes a physical connector 358 that is engageable with a physical connector 360 of a handle portion 362 to attach the handle portion 362 to the body 312 of the mouse module 310 (e.g., as shown in FIG. 5, etc.). As shown in FIG. 5, when the handle portion 362 is attached to the mouse module 310, the body 312 of the mouse module 310 is at the angular position of the body 12 shown in FIG. 4B wherein a longitudinal axis 326 of the body 312 extends at the approximately oblique angle 50 relative to the tracking surface 20.

FIG. 6 illustrates another example of a handle portion 462 attached to a mouse module 410. The mouse module 410 includes a body 412 having a lower front edge portion 440 that includes a slope 440a between a front face 438 and a lower side 434 of the body 412. The body 412 includes a physical connector 458 that is engageable with a physical connector 460 of a handle portion 462 to attach the handle portion 462 to the body 412 of the mouse module 410 (e.g., as shown in FIG. 6, etc.). When the handle portion 462 is attached to the mouse module 410, the body 412 of the mouse module 410 is at the angular position of the body 12 shown in FIG. 4C wherein a longitudinal axis 426 of the body 412 extends at the approximately oblique angle 52 relative to the tracking surface 20.

The handle portions 362 and 462 shown in FIGS. 5 and 6, respectively, are meant as exemplary only. In other words, the handle portions shown and/or described herein are non-limiting examples of handle portions that may be used with the mouse modules disclosed herein. Any other type, design, geometry, and/or the like of handle portions may be used with the mouse modules disclosed herein, for example to meet the preferences and/or specific needs of one or more users.

The physical connectors 358, 360, 458, and 460 respectively shown in FIGS. 5 and 6 are meant as exemplary only (i.e., the physical connectors shown and/or described herein are non-limiting examples of connectors that may be used to attach a handle portion to a mouse module). Any other type, design, geometry, location along the bodies 312 and/or 412, and/or the like of physical connectors may be used with the mouse modules disclosed herein, for example to meet the preferences and/or specific needs of one or more users. For example, in some implementations, the physical connectors 358, 360, 458, and/or 460 include one or more guide elements, one or more locking mechanisms and/or hooks, one or more eject and/or unhook buttons, another location along the body 312 and/or 412 than shown herein (e.g., a location along the lower side 334 of the body 312, a location along the lower side 434 of the body 412, etc.), and/or the like.

Referring again to FIG. 1, various parameters of the mouse module 10 (e.g., various parameters of the slope 40a and/or the position of the movement sensor 14, etc.) along the lower front edge portion 40 may be selected, for example to provide a predetermined number of different longitudinal angular positions at which the mouse module 10 is functional to detect movement thereof along the tracking surface 20. Examples of the various parameters of the mouse module 10 that may be selected include, but are not limited to, the particular angle of each different longitudinal angular position at which the mouse module 10 is functional, the number of different longitudinal angular positions at which the mouse module 10 is functional, the range of longitudinal angular positions at which the mouse module 10 is functional, the radius of curvature of the slope 40a and/or one or more segments thereof, the number of approximately straight segments of the slope 40a, the particular angle of an approximately straight segment of the slope 40a, and/or the like. In some implementations, various parameters of the mouse module 10 (e.g., various parameters of the slope 40a and/or the position of the movement sensor 14, etc.) are selected to accommodate the attachment of one or more particular handle portions.

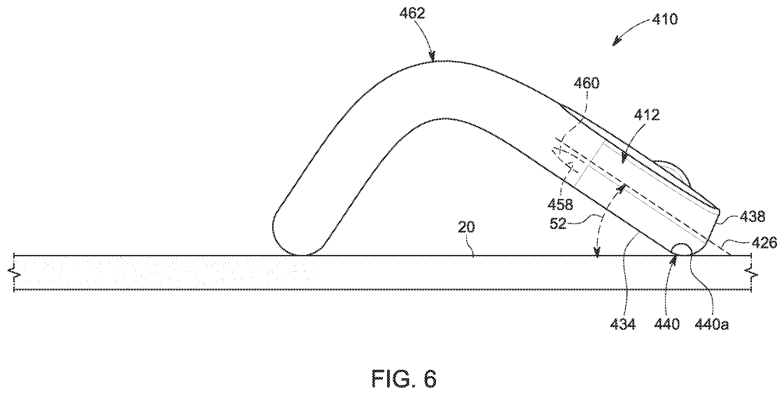

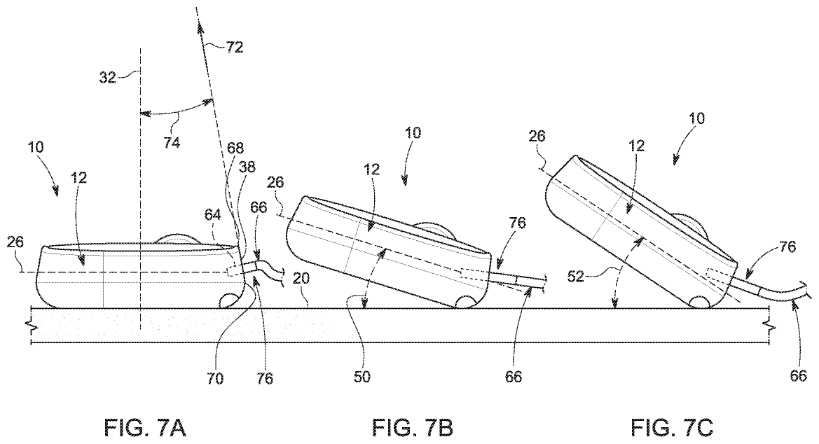

Referring now to FIG. 7, as described above, in some implementations the mouse module 10 includes a wired connection, for example for transmitting data between the mouse module 10 and a connected device and/or for receiving electrical power from a power source. In the exemplary implementation of FIG. 7, the mouse module 10 includes a connector 64 that is configured to be removably connected to an exemplary cable 66. As shown in FIG. 7, the connector 64 is positioned (e.g., extends, etc.) at the front face 38 of the body 12. In other words, the connector 64 is positioned along the front face 38. In some other implementations, in addition or alternatively to including the connector 64, a cable (e.g., the cable 66, etc.) is hard-wired to the mouse module 10 (e.g., the mouse module 510 shown in FIG. 8 having a cable 566 that is hardwired thereto, etc.) at the front face 38 of the body 12. The connector 64 may be an optical connector, an electrical connector, or a combined optical and electrical connector. The connector 64 may be any type of connector that is configured to be removably connected to any type of cable and/or connector terminating the cable, such as, but not limited to, a receptacle, a plug, a USB connector, a lightning connector, a thunderbolt connector, a USB-C connector, an electrical plug or receptacle, and/or the like. In the exemplary implementation of FIG. 7, the connector 64 is a USB receptacle connector.

Referring now to FIG. 7A, the front face 38 of the body 12 of the mouse module extends between an upper edge 68 of the front face 38 and a lower edge 70 of the front face 38. In some implementations, the front face 38 is angled backwardly toward the rear 28 of the body 12. For example, the front face 38 extends from the lower edge 70 toward the upper edge 68 in a direction 72 generally toward (e.g., that will eventually intersect, etc.) the central height axis 32 of the body 12, as shown in FIG. 7A. Although shown as having a backward angle 74 of approximately 10° relative to the central height axis 32, the front face 38 may be angled backwardly toward the rear 28 of the body 12 an any angle relative to the central height axis 32, such as, but not limited to, between approximately 5° and approximately 20°, between approximately 9° and approximately 19°, greater than approximately 5°, at least approximately at least approximately 30°, at least approximately 45°, and/or the like.

The backward angle 74 of the front face 38 of the mouse module 10 increases the flexibility of the mouse module 10. For example, the backward angle 74 of the front face 38 enables the mouse module 10 to be used at oblique longitudinal angular positions while the cable 66 is connected to the connector 64 of the mouse module 10. At least some known mice are not functional at longitudinal angles that are non-parallel to the tracking surface when a cable is connected or hardwired to the mouse. For example, the end of the cable that is connected or hardwired to at least some known mice will engage in physical contact with (e.g., abut, bump, push, contact, etc.) the tracking surface, and thereby inhibit movement and/or function of the mouse, when the mouse is tilted forward into an oblique longitudinal angular position relative to the tracking surface. However, the backward angle 74 of the front face 38 enables the mouse module 10 to function with the cable 66 connected to the connector 64 even when the longitudinal axis 26 is angled approximately obliquely relative to the tracking surface 20. For example, the backward angle 74 of the front face 38 changes the angle at which an end 76 of the cable 66 extends outward from the front face 38 (e.g., as compared to at least some known mice, etc.) such that the cable end 76 does not engage in physical contact with the tracking surface 20 when the body 12 of the mouse module 10 is tilted forward into an oblique longitudinal angular position.

For example, FIG. 7B illustrates that the cable end 76 does not engage in physical contact with the tracking surface 20 when the body 12 is at the angular position shown in FIGS. 4B and 7B wherein the longitudinal axis 26 extends at the approximately oblique angle 50 relative to the tracking surface 20. Moreover, and for example, FIG. 7C illustrates that the cable end 76 does not engage in physical contact with the tracking surface 20 when the body 12 is at the angular position shown in FIGS. 4C and 7C wherein the longitudinal axis 26 extends at the approximately oblique angle 52 relative to the tracking surface 20. Accordingly, the end 76 of the cable 66 does not interfere with movement and/or function of the mouse module 10 in either of the oblique longitudinal angular positions shown in FIGS. 7B and 7C. The backward angle 74 of the front face 38 thus increases the flexibility of the mouse module 10 by enabling the mouse module 10 to be used at oblique longitudinal angular positions while a cable (e.g., the cable 66 shown in FIG. 7, the cable 566 shown in FIG. 8, etc.) is removably connected to and/or hardwired to the mouse module 10.

The value of the backward angle 74 of the front face 38 of the body 12 may be selected, for example: to provide a predetermined range of oblique longitudinal angular positions within which the mouse module 10 is configured to function while a cable is removably connected and/or hardwired thereto; to provide a maximum angle of an oblique longitudinal angular position in which the mouse module 10 is capable of functioning while a cable is removably connected and/or hardwired thereto; etc.

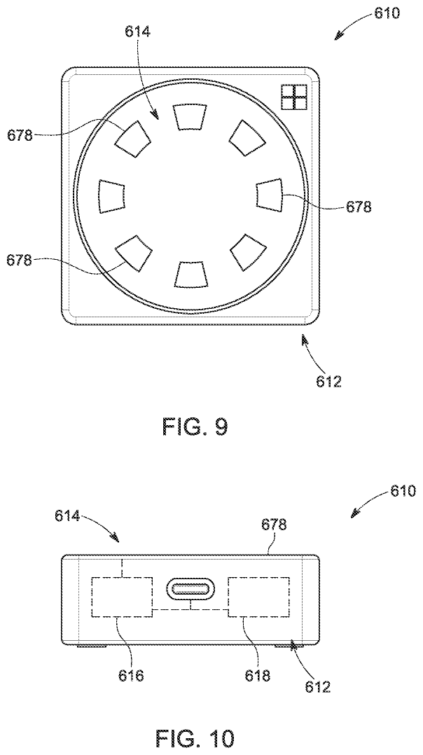

Referring now to FIGS. 9 and 10, an implementation of an input device 610 includes a body 612, a switch array 614, one or more encoders 616 operatively connected to the switch array 614, and one or more transmitters 618 operatively connected to the encoder 616. The switch array 614 includes a plurality of tactile switches 678. In operation, activation of the switches 678 is encoded by the encoder 616 for transmission to a connected device (not shown; e.g., a computer, a tablet, a phone, a portable electronic device, etc.). Optionally, the input device 610 is a mouse module (e.g., the mouse modules 10, 110, 210, 310, 410, and 510 shown in FIGS. 1, 2, 3, 5, 6, and 8, respectively, etc.) that includes a movement sensor (not shown in FIGS. 9 and 10; e.g., the movement sensor 14 shown in FIGS. 1 and 4, etc.) that is configured to detect movement of the input device 610 along a tracking surface. For example, in some implementations the body 612 of the input device 610 includes a lower front edge portion that includes a slope (e.g., the slope 40a shown in FIGS. 1 and 4, the slope 140a shown in FIG. 2, the slope 240a shown in FIG. 3, the slope 340a shown in FIG. 5, the slope 440a shown in FIG. 6, etc.) and/or includes a front face that is angled backwardly toward a rear of the body 612 (e.g., the front face 38 shown in FIGS. 1, 4, and 7, the front face 138 shown in FIG. 2, the front face 238 shown in FIG. 3, the front face 338 shown in FIG. 5, the front face 438 shown in FIG. 6, etc.). In some implementations, the input device 610 is removably attachable (e.g., detachable from and re-attachable to, etc.) a handle portion (e.g., the handle portions 362 and 462 shown respectively in FIGS. 5 and 6, etc.) that facilitates a user holding, grasping, manipulating, and/or the like the input device 610.

The input device 610 may be powered by any suitable power source(s) that enables the input device 610 to function as described and/or illustrated herein, such as, but not limited to, one or more batteries (e.g., rechargeable batteries, disposable batteries, permanent batteries, removable batteries, etc.), a wired connection (e.g., a universal serial bus (USB) connection, a cable that is hard-wired to the mouse module 10, an electrical connector for removable connection to a cable, etc.) for receiving power from a power supply (e.g., a computer, a tablet, a phone, a portable electronic device, a wall outlet, etc.), one or more capacitors and/or one or more super capacitors that use motion of the input device 610 to generate a charge that is stored in the capacitor(s) and/or super capacitor(s) to power the input device 610. In some implementations, in addition or alternatively to a wired connection that provides power to the input device 610, the input device 610 includes a wired connection (e.g., a USB connection, a cable that is hard-wired to the input device 610, an electrical and/or optical connector for removable connection to a cable, etc.) for transmitting data between the input device 610 and the connected device. In one example, the wired connection is a USB connection and the input device 610 includes a USB transceiver and/or the like. In addition or alternatively to a wired connection, the input device 610 may wirelessly communicate data with the connected device, such as, but not limited to, using Bluetooth®, WiFi®, a cellular network, infrared radiation, radio signals, and/or the like.

As best seen in FIG. 9, in the exemplary implementation the switch array 614 of the input device 610 includes eight tactile switches 678 arranged in an approximately circular pattern. However, the switch array 614 of the input device 610 may include any number of the switches 678 (e.g., one, two, three, four, six, at least ten, sixteen, etc.), for example a number that enables the input device 610 to function as described and/or illustrated herein. Moreover, the switches 678 may be arranged in any other pattern in addition or alternatively to the approximately circular pattern shown herein, such as, but not limited to, square, rectangular, triangular, side-by-side, diamond, hexagonal, octagonal, and/or the like patterns.

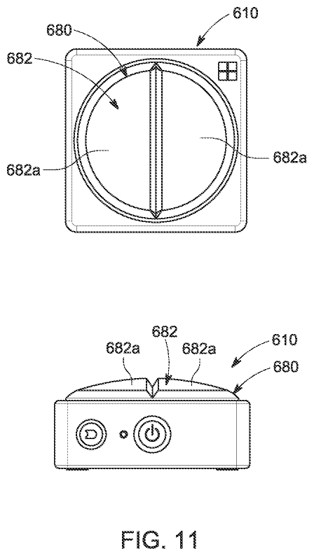

Referring now to FIGS. 9-18, the switch array 614 is configured to receive an input element 680 (shown in FIGS. 11-18) that includes one or more inputs 682 (shown in FIGS. 11-18; e.g., buttons, touch sensitive surfaces, rocker switches, joysticks, d-pads, haptic modules, etc.) that is configured to activate one or more of the switches 678 of the array 614 when the input 682 is manipulated by a user. The input device 610 is modular such that different input elements 680 can be selectively interchanged on the input device 610 to selectively provide the input device 610 with different input functionality. In other words, the input device 610 utilizes an array 614 of switches 678 with swappable input elements 680. By swapping in a different input element 680, the function of the input device 610 can be transformed. In this way, an input element 680 that is installed over the switch array 614 can be replaced by a different input element 680 with an alternative input configuration, layout, geometry, size, physical design, and/or the like (e.g., different combinations of buttons, touch sensitive surfaces, rocker switches, joysticks, d-pads, haptic modules, etc.). Accordingly, the input device 610 may be customized, enhanced, and/or the like with the addition of multiple input elements 680 including, but not limited to, the particular input elements 680 disclosed herein.

The input elements 680 may be installed to the input device 610 over the switch array 614 using any type of connection, such as, but not limited to, an interference fit, a snap fit, a latch, a clip, a pin, a threaded fastener, and/or the like.

The functions of the inputs 682 of each input element 680 are mapped to the corresponding switch(es) 678 that are activated by manipulation of the input 682 into physical contact with the corresponding switch(es) 678, for example using software (e.g., accessed via a graphical user interface (GUI) on the connected device, etc.) such as, but not limited to, an application, a macro, and/or the like. For example, each input 682 of an input element 680 installed to the input device 610 is mapped to a corresponding action such that when the input 682 is manipulated to activate the corresponding switch(es) 678, the input device 610 transmits the action to the connected device. In other words, as different input elements 680 are installed to the input device 610, the functions of the input device 610 are configured to match the functions of the particular input element 680 installed thereto.

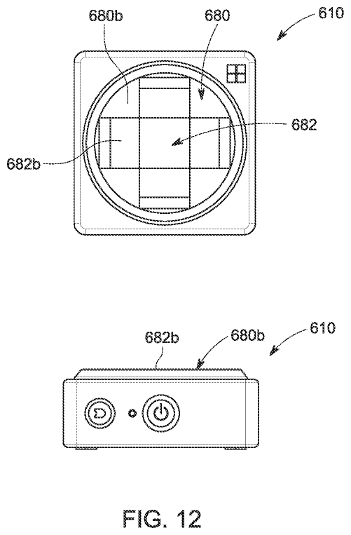

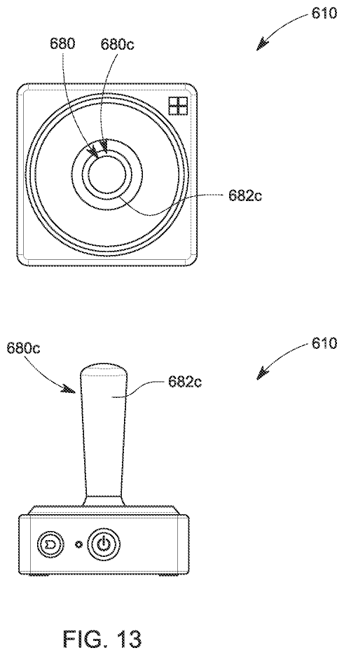

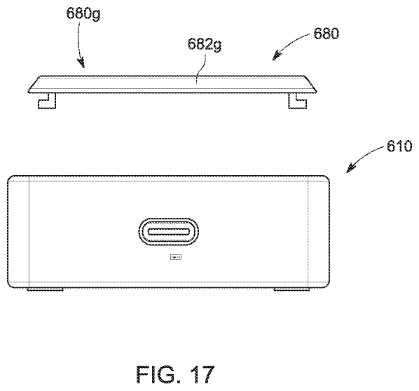

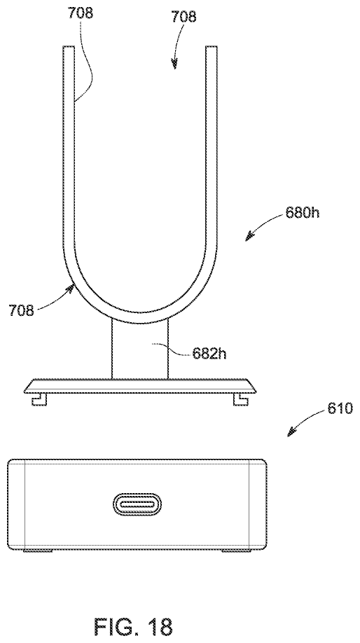

As described above, examples of various inputs 682 that may be included on the various input elements 680 include, but are not limited to, buttons (e.g., the buttons 686 shown in FIG. 11, etc.), touch sensitive surfaces, rocker switches (e.g., the rocker switch 698 shown in FIG. 17, the rocker switch 700 shown in FIG. 18, etc.), joysticks (e.g., the joysticks 690, 692, 694, and 696 shown in FIGS. 13-16, respectively, etc.), d-pads (e.g., the d-pad 688 shown in FIG. 12, etc.), haptic modules, and/or the like. In one example, button, scroll, swipe, and/or the like functionality is provided by one or more touch sensitive surfaces that interact with one or more of the switches 678 (e.g., an input element 680 includes a touch sensitive surface element 682 that is configured to activate two or more of the switches 678 to provide touch surface functionality, etc.). In some implementations, an input element 680 may include a haptic device configured to generate vibrations, for example to provide feedback (e.g., indicating a button click, a scroll, a swipe, etc.) to a user of the input device 610, to provide a constant stimulation to a user so that the user can better control the input device 610, and/or the like.

As described above, the various input elements 680 include different configurations, layouts, geometries, sizes, physical designs, and/or the like of the inputs 682. Examples of configurations, layouts, geometries, sizes, physical designs, and/or the like of the input elements 680 include, but are not limited to, an 8-way joystick, a 4-way joystick, a 2-way vertical rocker switch, a 2-way horizontal rocker switch, an 8-way d-pad, a 4-way d-pad, a single button, two buttons, four buttons, eight buttons, and/or the like. The configurations, layouts, geometries, sizes, physical designs, and/or the like of the input elements 680 shown and/or described herein are meant as exemplary only. In other words, the configurations, layouts, geometries, sizes, physical designs, and/or the like of the input elements 680 shown and/or described herein are non-limiting examples of input elements that may be installed to the input device 610. Any other configuration, layout, geometry, size, physical design, and/or the like of an input element may be configured to be installed to the input device 610, for example to meet the preferences and/or specific needs of one or more users.

For example, FIG. 11 illustrates an assembly of the input device 610 with an input element 680a installed thereto. The input element 680a includes two button inputs 682a that interact with the switch array 614 (not visible in FIG. 11) to provide the input device 610 with a two-button input functionality.

FIG. 12 illustrates an assembly of the input device 610 with an input element 680b installed thereto. The input element 680b includes a 4-way d-pad input 682b that interacts with the switch array 614 (not visible in FIG. 12) to provide the input device 610 with a 4-way d-pad input functionality.

As shown in FIG. 13, the input device 610 is assembled with an input element 680c that includes a joystick input 682c (e.g., a 2-way joystick, a 4-way joystick, an 8-way joystick, etc.) that interacts with the switch array 614 (not visible in FIG. 13) to provide the input device 610 with a joystick input functionality.

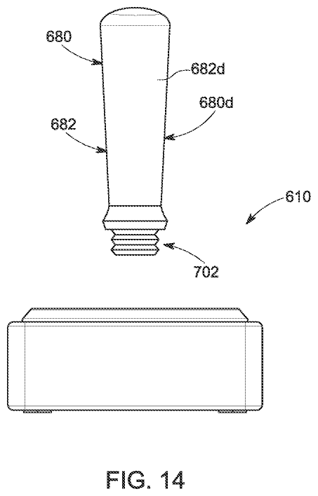

FIG. 14 illustrates another implementation wherein the input device 610 is assembled with an input element 680d that includes a joystick input 682d (e.g., a 2-way joystick, a 4-way joystick, an 8-way joystick, etc.). The joystick input 682d interacts with the switch array 614 (not visible in FIG. 14) to provide the input device 610 with a joystick input functionality. As can be seen in the exploded view of FIG. 14, the exemplary implementation of the joystick input 682d is installed to the input device 610 using an exemplary threaded fastener 702.

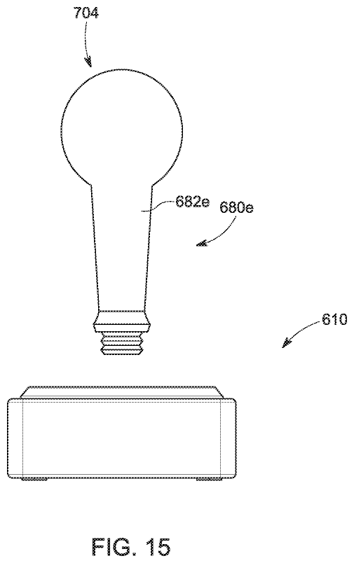

FIG. 15 illustrates another implementation wherein the input device 610 is assembled with an input element 680e that includes a joystick input 682e (e.g., a 2-way joystick, a 4-way joystick, an 8-way joystick, etc.). The joystick input 682e interacts with the switch array 614 (not visible in FIG. 15) to provide the input device 610 with a joystick input functionality. The joystick input 682e has a relatively larger and more bulbous end 704 (e.g., as compared to the joystick inputs 682c and 682d shown respectively in FIGS. 13 and 14, etc.), for example to increase accessibility. For example, the relatively larger and more bulbous end 704 may facilitate: accommodating user's having relatively less strength, movement, and/or dexterity in their arms, hands, fingers, and/or the like; enabling the joystick input 682e to be controlled with a foot, elbow, head, chin, residual limb, and/or the like; etc.

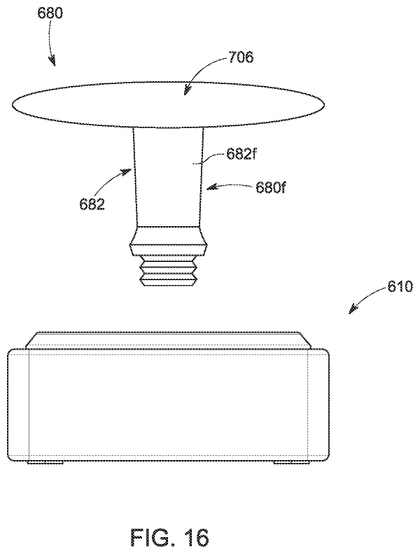

Another implementation of a joystick input 682f is shown in FIG. 16. Specifically, the input device 610 illustrated in FIG. 16 is assembled with an input element 680f that includes the joystick input 682f (e.g., a 2-way joystick, a 4-way joystick, an 8-way joystick, etc.). The joystick input 682f interacts with the switch array 614 (not visible in FIG. 16) to provide the input device 610 with a joystick input functionality. The joystick input 682f has an approximately planar end 706, for example to increase accessibility. For example, the approximately planar end 706 of the joystick input 682f may facilitate: accommodating user's having relatively less strength, movement, and/or dexterity in their arms, hands, fingers, and/or the like; enabling the joystick input 682f to be controlled with a foot, elbow, head, chin, residual limb, and/or the like; etc.

As shown in FIG. 17, the input device 610 is assembled with an input element 680g that includes a 2-way rocker switch input 682g (e.g., a 2-way horizontal rocker switch, a 2-way vertical rocker switch, etc.) that interacts with the switch array 614 (not visible in FIG. 17) to provide the input device 610 with a rocker switch input functionality.

FIG. 18 illustrates another implementation of an input element 680h. Specifically, the input device 610 illustrated in FIG. 18 is assembled with the input element 680h, which includes a cradle input 682h that interacts with the switch array 614 (not visible in FIG. 18) to provide the input device 610 with at least one of a button input functionality, a joystick input functionality, a rocker switch input functionality, and/or the like. The cradle input 682h includes a cradle 708 that, in some implementations, is configured to receive a foot, elbow, head, chin, residual limb, and/or the like therein, for example to facilitate enabling the cradle input 682h to be controlled with a foot, elbow, head, chin, residual limb, and/or the like, etc.

The input device 610 is adaptable to a user's particular needs. For example, users are able to create, select, adapt, and/or customize the functionality of the input element 680 to match the user's specific needs. For example, a user may create and/or select an input element 680 that is adapted for the user's needs, hand-size, hand strength, hand shape, finger strength, finger shape, and/or the like. Moreover, and for example, a user may create and/or select an input element 680 that provides an ergonomic benefit to the user, increases the user's comfort while using the input device 610, and/or decreases the likelihood of injury (e.g., carpal tunnel syndrome, other repetitive strain injuries, etc.) resulting from use of the input device 610. In another example, a particular input element 680 may be selected and/or created to increase accessibility, for example: to accommodate a particular (e.g., custom, bespoke, specialized, etc.) input element 680; for a user who has a motor skill limitation (e.g., neurological disorders, Cerebral Palsy, Parkinson's disease, etc.); to enable the input device 610 to be controlled with a foot, elbow, head, chin, residual limb, and/or the like; to accommodate user's having relatively less strength, movement, and/or dexterity in their arms, hands, fingers, and/or the like; etc.

In some implementations, one or more input elements 680 is fabricated using three-dimensional (3D) printing, an additive manufacturing technique, a rapid manufacturing technique, and/or another technique that forms an input element 680 by adding material or removing material. 3D printing, additive manufacturing, and techniques may enable ease of prototyping and a custom mouse input element 680 design for an individual user.

In addition or alternative to what is described above, the functionality described for a mouse module and/or an input device is performed, at least in part, by one or more hardware logic components contained within the mouse module and/or input device. For example, and without limitation, illustrative types of hardware logic components that are optionally used include Field-Programmable Gate Arrays (FPGAs), Application-Specific Integrated Circuits (ASICs), Application-Specific Standard Products (ASSPs), System-On-a-Chip systems (SOCs), Complex Programmable Logic Devices (CPLDs) and Computer Processing Units (CPUs). The one or more hardware logic components are operable to receive and transmit data between components of the mouse module and/or input device. The one or more hardware logic components may be further operable to control the receiving and transmission of data between components within the mouse module and/or input device and components within a handle portion using one or more protocols. In this manner, devices within the handle portion may be controlled by the one or more hardware logic components. If a handle portion comprises one or more sensors, data collected from such one or more sensors may be transmitted to the one or more hardware logic components. The one or more hardware logic components may be yet further operable to receive and transmit data between components within the mouse module and/or input device and a connected computer.

The following examples describe further aspects:

In one example, a computer mouse module comprises a body comprising a front face, a lower side, and a lower front edge portion that extends between the lower side and the front face. The lower front edge portion comprises a slope between the front face and the lower side. A movement sensor held along the slope of the lower front edge portion of the body. The movement sensor is configured to detect movement of the computer mouse module along a tracking surface at at least two angular positions of a longitudinal axis of the body relative to the tracking surface.

The slope of the lower front edge portion may comprise a curvature.

The slope of the lower front edge portion may comprise a convexly curved path between the front face and the lower side of the body.

The movement sensor may be configured to detect movement of the computer mouse module along the tracking surface: at a first angular position of the body relative to the tracking surface wherein the longitudinal axis of the body extends approximately parallel to the tracking surface; and at a second angular position of the body relative to the tracking surface wherein the longitudinal axis of the body extends at an approximate oblique angle relative to the tracking surface.

The movement sensor may be configured to detect movement of the computer mouse module along the tracking surface over a range of approximately oblique angles of the longitudinal axis of the body relative to the tracking surface.

The body may comprise a foot extending along the slope of the lower front edge portion of the body.

The body may comprise a foot extending along a convexly curved path along the slope of the lower front edge portion of the body.

The body may comprise a physical connector for detachably attaching a handle portion to the body of the computer mouse module.

In one example, a computer mouse module comprises a body extending a length from a rear to a front. The front of the body includes a front face. The front face is angled backwardly toward the rear of the body. At least one of a cable or a cable connector extends at the front face of the body.

The body extends a height along a central height axis from a lower side of the body to an upper side of the body. The front face may extend from a lower edge of the front face toward an upper edge of the front face in a direction generally toward the central height axis of the body.

The body extends a height along a central height axis from a lower side of the body to an upper side of the body. The front face may be angled between approximately 5 and approximately 20 relative to the central height axis.

The at least one of a cable or a cable connector may comprise a universal serial bus (USB) receptacle connector.

In one example, a computer mouse module comprises a body extending a length from a rear to a front. The body comprises a front face, a lower side, and a lower front edge portion that extends between the lower side and the front face. The lower front edge portion comprises a slope between the front face and the lower side. The front face is angled backwardly toward the rear of the body. A movement sensor is held along the slope of the lower front edge portion of the body. The movement sensor is configured to detect movement of the computer mouse module along a tracking surface at at least two angular positions of a longitudinal axis of the body relative to the tracking surface. At least one of a cable or a cable connector extends at the front face of the body.

The slope of the lower front edge portion may comprise a convexly curved path between the front face and the lower side of the body.

The movement sensor may be configured to detect movement of the computer mouse module along the tracking surface: at a first angular position of the body relative to the tracking surface wherein the longitudinal axis of the body extends approximately parallel to the tracking surface; and at a second angular position of the body relative to the tracking surface wherein the longitudinal axis of the body extends at an approximate oblique angle relative to the tracking surface.

The movement sensor may be configured to detect movement of the computer mouse module along the tracking surface over a range of approximately oblique angles of the longitudinal axis of the body relative to the tracking surface.

The body may comprise a foot extending along a convexly curved path along the slope of the lower front edge portion of the body.

The body extends a height along a central height axis from the lower side of the body to an upper side of the body. The front face may be angled between approximately 5 and approximately 20 relative to the central height axis.

The at least one of a cable or a cable connector may comprise a universal serial bus (USB) receptacle connector.

The body may comprise a physical connector for detachably attaching a handle portion to the body of the computer mouse module.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

Various functions of the mouse modules and/or input devices disclosed herein may be performed, in some examples, by software using one or more processors (not shown; e.g., microprocessors, etc.) for processing computer executable instructions. In some implementations, platform software comprising an operating system and/or any other suitable platform software is provided on the mouse modules and/or input devices disclosed herein to enable application software to be executed thereon. Computer executable instructions are provided using any computer-readable media. Computer-readable media include, for example and without limitation, computer storage media and communications media. Computer storage media, such as a memory, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media embody computer readable instructions, data structures, program modules, and/or the like in a modulated data signal, such as a carrier wave and/or other transport mechanism. As defined herein, computer storage media do not include communication media. Therefore, a computer storage medium should not be interpreted to be a propagating signal per se. Propagated signals per se are not examples of computer storage media.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or value given herein can be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above can relate to one implementation or can relate to several implementations. The implementations are not limited to those that solve any or all of the stated problems or those that have any or all of the stated benefits and advantages. It will further be understood that reference to ‘an’ item refers to one or more of those items.

The order of execution or performance of the operations in examples of the present application illustrated and described herein is not essential, unless otherwise specified. That is, the operations can be performed in any order, unless otherwise specified, and examples of the application can include additional or fewer operations than those disclosed herein. For example, it is contemplated that executing or performing a particular operation before, contemporaneously with, or after another operation (e.g., different steps, etc.) is within the scope of aspects and implementations of the application.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of” or, when used in the claims, “consisting of” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” only one of or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the application in detail, it will be apparent that modifications and variations are possible without departing from the scope of aspects of the application as defined in the appended claims. As various changes could be made in the above constructions, products, and methods without departing from the scope of aspects of the application, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

1. A computer mouse module comprising:
a body comprising a front face, a lower side, and a lower front edge portion that extends between the lower side and the front face, the lower front edge portion comprising a slope between the front face and the lower side; and
a movement sensor held along the slope of the lower front edge portion of the body, the movement sensor being configured to detect movement of the computer mouse module along a tracking surface at first and second angular positions of a longitudinal axis of the body relative to the tracking surface, wherein the longitudinal axis of the body extends parallel, or close to parallel, to the tracking surface in the first angular position, and wherein the body is configured to be tilted forward from the first angular position to the second angular position such that the longitudinal axis of the body extends at an oblique angle relative to the tracking surface in the second angular position.

2. The computer mouse module of claim 1, wherein the slope of the lower front edge portion comprises a curvature.

3. The computer mouse module of claim 1, wherein the slope of the lower front edge portion comprises a convexly curved path between the front face and the lower side of the body.

4. (canceled)

5. The computer mouse module of claim 1, wherein the movement sensor is configured to detect movement of the computer mouse module along the tracking surface over a range of approximately oblique angles of the longitudinal axis of the body relative to the tracking surface.

6. The computer mouse module of claim 1, wherein the body comprises a foot extending along the slope of the lower front edge portion of the body.

7. The computer mouse module of claim 1, wherein the body comprises a foot extending along a convexly curved path along the slope of the lower front edge portion of the body.

8. The computer mouse module of claim 1, wherein the body comprises a physical connector for detachably attaching a handle portion to the body of the computer mouse module.

9. A computer mouse module comprising:
a body extending a length along a longitudinal axis from a rear to a front, the front of the body comprising a front face, wherein the front face is angled backwardly toward the rear of the body such that the front face includes a backwardly-angled segment that extends at an oblique angle relative to the longitudinal axis; and
at least one of a cable or a cable connector extending outward from the backwardly-angled segment of the front face of the body such that the at least one of the cable or the cable connector extends outward from the front face at an oblique angle relative to the longitudinal axis of the body.

10. The computer mouse module of claim 9, wherein the body extends a height along a central height axis from a lower side of the body to an upper side of the body, the front face extending from a lower edge of the front face toward an upper edge of the front face in a direction generally toward the central height axis of the body.

11. The computer mouse module of claim 9, wherein the body extends a height along a central height axis from a lower side of the body to an upper side of the body, the front face being angled between approximately 5 and approximately 20 relative to the central height axis.

12. The computer mouse module of claim 9, wherein the at least one of a cable or a cable connector comprises a universal serial bus (USB) receptacle connector.

13. A computer mouse module comprising:
a body extending a length from a rear to a front, the body comprising a front face, a lower side, and a lower front edge portion that extends between the lower side and the front face, the lower front edge portion comprising a slope between the front face and the lower side, wherein the front face is angled backwardly toward the rear of the body such that the front face includes a backwardly-angled segment that extends at an oblique angle relative to a longitudinal axis of the body;
a movement sensor held along the slope of the lower front edge portion of the body, the movement sensor being configured to detect movement of the computer mouse module along a tracking surface at at least two angular positions of the longitudinal axis of the body relative to the tracking surface; and
at least one of a cable or a cable connector extending outward from the backwardly-angled segment of the front face of the body such that the at least one of the cable or the cable connector extends outward from the front face at an oblique angle relative to the longitudinal axis of the body.

14. The computer mouse module of claim 13, wherein the slope of the lower front edge portion comprises a convexly curved path between the front face and the lower side of the body.

15. The computer mouse module of claim 13, wherein the movement sensor is configured to detect movement of the computer mouse module along the tracking surface:
at a first angular position of the body relative to the tracking surface wherein the longitudinal axis of the body extends approximately parallel to the tracking surface; and
at a second angular position of the body relative to the tracking surface wherein the longitudinal axis of the body extends at an approximate oblique angle relative to the tracking surface.

16. The computer mouse module of claim 13, wherein the movement sensor is configured to detect movement of the computer mouse module along the tracking surface over a range of approximately oblique angles of the longitudinal axis of the body relative to the tracking surface.

17. (canceled)

18. The computer mouse module of claim 13, wherein the body extends a height along a central height axis from the lower side of the body to an upper side of the body, the front face being angled between approximately 5 and approximately 20 relative to the central height axis.

19. The computer mouse module of claim 13, wherein the at least one of a cable or a cable connector comprises a universal serial bus (USB) receptacle connector.

20. (canceled)

21. The computer mouse module of claim 9, wherein the body extends a height along a central height axis from a lower side of the body to an upper side of the body, the front face being angled less than 21° relative to the central height axis.

22. The computer mouse module of claim 1, wherein the body is configured to be tilted forward from the second angular position to a third angular position of the body wherein the longitudinal axis of the body extends at another oblique angle relative to the tracking surface, wherein the movement sensor is configured to detect movement of the computer mouse module along the tracking surface at the third angular position.

23. The computer mouse module of claim 9, wherein the cable connector extends outward from the backwardly-angled segment of the front face of the body such that the cable connector extends outward from the front face at the oblique angle relative to the longitudinal axis of the body.
